(19) United States
(12) Patent Application Publication
(10) Pub. No.: US 2009/0187684 A1
(43) Pub. Date: Jul. 23, 2009

(54) AUTOMATIC INSPECTION SYSTEM AND METHOD FOR NOTEBOOK COMPUTER KEYBOARD INTERFACE

(75) Inventors: Xue-Shan HAN, Tianjin (CN); Juen LIOU, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/016,163

(22) Filed: Jan. 17, 2008

(51) Int. Cl. G06F 13/12

(52) U.S. Cl. 710/67

(57) ABSTRACT

An automatic inspection system and method for a notebook computer keyboard interface are described. The method includes the following steps including scanning a notebook computer keyboard array to obtain a keyboard position corresponding table; running a testing software in the notebook computer to obtain a position value of a key under test from the keyboard position corresponding table; receiving a testing command from the testing software by an USB interface; constituting a virtual keyboard matrix with at least one matrix switching chip, for controlling the close action of a corresponding key position in the virtual keyboard matrix according to the testing command; transferring the actual key position value corresponding to the output close action to the notebook computer according to the configuration of the notebook computer keyboard interface; and receiving and comparing the actual key position value with the position value of the key under test.

### BACKGROUND OF THE INVENTION

1. Field of Invention

The present invention relates to an automatic inspection system and a method thereof, and more particularly to a system for automatically inspecting a computer keyboard interface and a method thereof.

2. Related Art

During the manufacturing of a notebook computer, interfaces for connecting external parts to the motherboard of the notebook computer, including the keyboard interface, should all be tested. The keyboard of a notebook computer is of a matrix structure constituted by a certain number of column scan lines and row scan lines. Each key is located at a cross-point in the matrix, and the pressing of a key leads to the connection of a column and a row in the matrix. The notebook computer sends a scan signal to the column (row) lines in the keyboard interface, then reads the signal from the row (column) lines to determine the position of the key, and converts the position information into a set key code. The keyboard interface of the notebook computer motherboard mainly includes signal lines of the column, row lines. The signal lines may be classified into sending signal lines and receiving signal lines, and form a cross-point array. Keyboard interfaces of different types of computer motherboards have similar functions, and only differ in the number and position of the column, row lines. There are mainly 8×16, 8×18, and 15×12 three structures.

The keyboard interface is inspected by making sure whether the sending signal lines and receiving signal lines are connected or disconnected. At present, the computer keyboard is generally inspected by: connecting a real keyboard externally, and running a testing software to ensure the accuracy of the keyboard interface together with manual key-pressing interaction. However, the above conventional manner has the following disadvantages: 1. the interaction between an operator and a testing software is required, in which the testing software sends a command, and then waits for the operator to press a key; 2. the test time is long with low efficiency; 3. the operator may make a mistake when pressing a key, so the operation may be repeated; 4. the operator may slack off, and so on.

### SUMMARY OF THE INVENTION

To solve the above problems and defects in the conventional art, the present invention is directed to an automatic inspection system and method for a notebook computer keyboard interface, so as to achieve the purpose of automatically inspecting a keyboard interface with less manual participation, thereby improving the accuracy and efficiency of the inspection.

An automatic inspection system for a notebook computer keyboard interface, according to the present invention, includes an USB communication module, a matrix switching chip, an adaptor, and a comparison module. The USB communication module receives a command from a testing software through an USB interface, in which the testing software is run in the notebook computer and the command contains a position value of a key under test. The matrix switching chip constitutes a virtual keyboard matrix, so as to control the close action of a corresponding key position in the virtual keyboard matrix according to the command of the testing software transmitted by the USB communication module, and thus to simulate an actual key-pressing action of the keyboard of the notebook computer. The adaptor transfers an actual key position value corresponding to the close action output by the matrix switching chip to the notebook computer according to the configuration of the notebook computer keyboard interface. The comparison module is contained in the testing software, for receiving the actual key position value, and comparing the actual key position value with the position value of the key under test.

An automatic inspection method for a notebook computer keyboard interface, according to the present invention, includes the following steps: scanning a notebook computer keyboard array to obtain a keyboard position corresponding table; running a testing software in the notebook computer, so as to obtain a position value of a key under test from the keyboard position corresponding table; receiving a testing command sent from the testing software by an USB interface, in which the testing command includes a position value of a key under test; constituting a virtual keyboard matrix with at least one matrix switching chip, for controlling the close action of a corresponding key position in the virtual keyboard matrix according to the testing command, and thus to simulate an actual key-pressing action of the keyboard of the notebook computer; transferring the actual key position value corresponding to the output close action to the notebook computer according to the configuration of the notebook computer keyboard interface; and receiving the actual key position value by the testing software, and comparing the actual key position value with the position value of the key under test by the same, so as to complete the interface test on a key under test.

In the automatic inspection system and method for a notebook computer keyboard interface provided by the present invention, a particular matrix structure is constituted by a matrix switching chip, for substituting a real keyboard, and an USB port is used to receive a command from a testing software to control the open/close of a certain cross-point in the matrix, so as to simulate an actual key-pressing action. Therefore, the present invention achieves the purpose of automatically inspecting a keyboard interface of a notebook computer motherboard with less manual participation, thereby improving the accuracy and efficiency of the inspection.

### BRIEF DESCRIPTION OF THE DRAWINGS

The present invention will become more fully understood from the detailed description given herein below for illustration only, and thus are not limitative of the present invention, and wherein:

FIG. 1 is a system block diagram of an automatic inspection system for a notebook computer keyboard interface according to the present invention; and

FIG. 2 is a flow chart of the process of an automatic inspection method for a notebook computer keyboard interface according to the present invention.

### DETAILED DESCRIPTION OF THE INVENTION

The features and practice of the preferred embodiments of the present invention will be illustrated in detail below with the accompanying drawings.

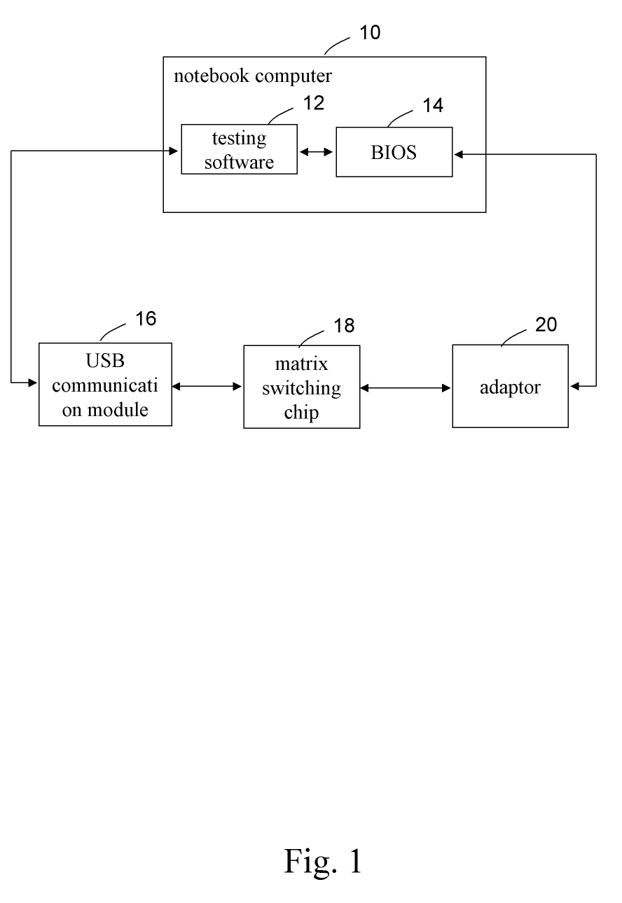

Referring to FIG. 1, an automatic inspection system for a notebook computer keyboard interface according to the present invention is shown. The system, run in a notebook computer 10, includes an USB communication module 16, a matrix switching chip 18 (preferably, implemented as an MT8816 chip or other similar switching elements), an adaptor 20, and a testing software 12. The USB communication module 16 may be an USB communication apparatus with a Cy7c68013 master chip, for receiving a command from the testing software 12 run in the notebook computer 10 through an USB port and converting the command into a control signal. The command transmitted to the USB communication module 16 by the testing software 12 includes a position value of a key under test, i.e., the column, row values of the key in the notebook computer 10.

The matrix switching chip 18 is connected to an output end of the USB communication module 16, for receiving the control signal sent by the USB communication module 16. In a following preferred embodiment of the present invention, an MT8816 chip serving as the matrix switching chip 18 is taken as an example; however, the present invention is not limited thereto, and any other switching element with similar functions falls within the protection scope of the present invention. For example, the matrix switching chip 18 may be at least one MT8816 chip, for constituting a virtual keyboard matrix, so as to control the open/close of a cross-point corresponding to the key position in the virtual keyboard matrix according to the command of the testing software transmitted by the USB communication module, and thus to simulate an actual key-pressing action of the keyboard of the notebook computer 10. According to the configuration of the keyboard of the tested notebook computer, the MT8816 switching chip may be one MT8816 chip, for constituting an 8×16 virtual keyboard matrix; or may be two MT8816 chips, for constituting an 8×16, 8×32, or 16×16 virtual keyboard matrix, thus covering all kinds of keyboard interfaces available at present.

Referring to FIG. 1, the adaptor 20 is connected between an X/Y line interface of the matrix switching chip 18 of an MT8816 chip and a BIOS 14 of the notebook computer 10, for converting a signal sent from the MT8816 keyboard matrix. As the number and position of the column, row lines of keyboard interfaces differ in different notebook computer motherboards, an adaptor is needed to make the MT8816 keyboard matrix compatible with different interfaces, and reflect the state of the keyboard into the notebook computer 10. The adaptor 20 is connected to the keyboard matrix constituted by the MT8816 chip through the X/Y line interface. The X/Y lines include signal lines of the column (X) and row (Y) lines in the MT8816 keyboard matrix, and are connected to a keyboard interface of the motherboard of the notebook computer 10 through a scan line interface. The adaptor 20 is used for making the sequences of the column, row lines of the MT8816 keyboard matrix match the sequences of the column, row lines in the keyboard interface of the motherboard of the notebook computer 10.

The testing software 12 has a comparison module, for receiving an actual key position state value through the keyboard interface, and comparing the position state value with the position value of the key under test sent from the testing software 12, thus completing the test on a key.

Further, the automatic inspection system of the present invention further includes a scan software, for scanning a notebook computer keyboard array to obtain a keyboard position corresponding table, so as to provide the position value of the key under test to the testing software 12. In addition, the position corresponding table may also be provided by the manufacturer of the keyboard.

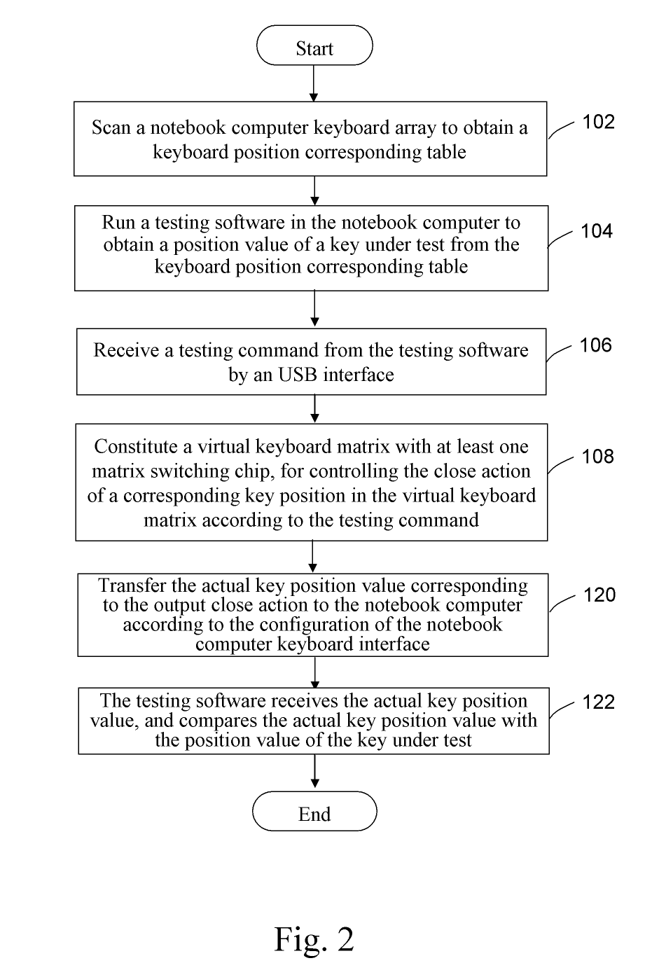

Next, referring to FIG. 2, a flow chart of the process of an automatic inspection method for a notebook computer keyboard interface according to the present invention is shown. As shown in FIG. 2, the automatic inspection method for a notebook computer keyboard interface includes the following steps. First, a “keyboard position corresponding table” showing positions of the keys of the real keyboard in the matrix is obtained for different notebook computers (Step 102), in which the position corresponding table is provided by the manufacturer of the keyboard or obtained through a scan software. All the cross-points in the array of the keyboard are scanned to obtain the key positions of the real keyboard. Thereby, when a key (for example, Key A) of the notebook computer is to be pressed, the testing software looks up the “keyboard position corresponding table” for the position (column, row values) of the key (Step 104). Next, an USB device receives a testing command sent from the testing software (Step 106), in which the testing command contains the position value of the key under test. The USB communication device may be an USB communication apparatus with a Cy7c68013 master chip, for receiving the testing command through an USB port, and converting the command into a control signal.

After that, the USB communication device sends the testing control signal to a virtual keyboard matrix constituted by at least one matrix switching chip, so as to control the open/close of a cross-point corresponding to the key position in the virtual keyboard matrix according to the command of the testing software transmitted by the USB communication device, and thus to simulate an actual key-pressing action of the keyboard of the notebook computer (Step 108). The matrix switching chip may be, for example, an MT8816 chip or any other switching element with similar functions. In this embodiment, the matrix switching chip may be one MT8816 chip, for constituting an 8×16 virtual keyboard matrix; or may be two MT8816 chips, for constituting an 8×16, 8×32, or 16×16 virtual keyboard matrix, thus covering all kinds of keyboard interfaces available at present.

According to the embodiment, the MT8816 matrix switching chip that constitutes a virtual keyboard matrix is connected to the adaptor 20, for converting a signal sent from the MT8816 virtual keyboard matrix (Step 120). The adaptor 20 is connected between an X/Y line interface of the MT8816 matrix switching chip and a BIOS of the notebook computer. As the number and position of the column, row lines of keyboard interfaces differ in different notebook computer motherboards, an adaptor is needed to make the MT8816 keyboard matrix compatible with different interfaces, and reflect the state of the keyboard into the notebook computer.

The adaptor is connected to the keyboard matrix constituted by the MT8816 chip through the X/Y line interface. The X/Y lines include signal lines of the column (X) and row (Y) lines in the MT8816 keyboard matrix, and are connected to a keyboard interface of the motherboard of the notebook computer through a scan line interface. The adaptor is used for making the sequences of the column, row lines of the MT8816 keyboard matrix match the sequences of the column, row lines in the keyboard interface of the motherboard of the notebook computer.

After a signal is transferred to the BIOS of the notebook computer, the actual key position state value is transmitted to the testing software, and thus the testing software compares the real keyboard position state value with the position value of the key under test sent from the testing software, so as to complete the test on the key (Step 122).

What is claimed is:

1. An automatic inspection system for a notebook computer keyboard interface, comprising:
an USB communication module, for receiving a command from a testing software through an USB interface, wherein the testing software is run in the notebook computer and the command contains a position value of a key under test;
a matrix switching chip, for constituting a virtual keyboard matrix, so as to control the close action of a corresponding key position in the virtual keyboard matrix according to the command of the testing software transmitted by the USB communication module, and thus to simulate an actual key-pressing action of the keyboard of the notebook computer;
an adaptor, for transferring an actual key position value corresponding to the close action output by the matrix switching chip to the notebook computer according to the configuration of the notebook computer keyboard interface; and
a comparison module, contained in the testing software, for receiving the actual key position value, and comparing the actual key position value with the position value of a key under test.

2. The automatic inspection system as claimed in claim 1, wherein the matrix switching chip comprises at least one MT8816 chip according to the configuration of the notebook computer keyboard interface.

3. The automatic inspection system as claimed in claim 2, wherein the matrix switching chip comprises one MT8816 chip, for constituting an 8×16 virtual keyboard matrix.

4. The automatic inspection system as claimed in claim 2, wherein the matrix switching chip comprises two MT8816 chips, for constituting an 8×16, 8×32, or 16×16 virtual keyboard matrix.

5. The automatic inspection system as claimed in claim 1, further comprising a scan software, for scanning a notebook computer keyboard array to obtain a keyboard position corresponding table, so as to provide the position value of the key under test to the testing software.

6. An automatic inspection method for a notebook computer keyboard interface, comprising:
scanning a notebook computer keyboard array to obtain a keyboard position corresponding table;
running a testing software in the notebook computer, so as to obtain a position value of a key under test from the keyboard position corresponding table;
receiving a testing command sent from the testing software by an USB interface, wherein the testing command comprises the position value of the key under test;
constituting a virtual keyboard matrix with at least one matrix switching chip, for controlling the close action of a corresponding key position in the virtual keyboard matrix according to the testing command, and thus to simulate an actual key-pressing action of the keyboard of the notebook computer;
transferring the actual key position value corresponding to the output close action to the notebook computer according to the configuration of the notebook computer keyboard interface; and
receiving the actual key position value by the testing software, and comparing the actual key position value with the position value of the key under test by the same, so as to complete the interface test on the key under test.

7. The automatic inspection method as claimed in claim 6, wherein the matrix switching chip comprises one MT8816 chip, for constituting an 8×16 virtual keyboard matrix.

8. The automatic inspection method as claimed in claim 6, wherein the matrix switching chip comprises two MT8816 chips, for constituting an 8×16, 8×32, or 16×16 virtual keyboard matrix.
